(19) United States
(12) Patent Application Publication
(10) Pub. No.: US 2017/0357954 A1
(43) Pub. Date: Dec. 14, 2017

(54) NETWORK FOR ONBOARDING AND DELIVERY OF ELECTRONIC PAYMENTS TO NEW PAYEES

(71) Applicants: Dean Tribble, Bellevue, WA (US); Paul F. Doyle, Ada, MI (US); Todd Tracey, Spring Lake, MI (US); Nicholas Sean Mathis, Rockford, MI (US)

(72) Inventors: Dean Tribble, Bellevue, WA (US); Paul F. Doyle, Ada, MI (US); Todd Tracey, Spring Lake, MI (US); Nicholas Sean Mathis, Rockford, MI (US)

(21) Appl. No.: 15/618,410

(22) Filed: Jun. 9, 2017

Related U.S. Application Data
(60) Provisional application No. 62/347,876, filed on Jun. 9, 2016.

(51) Int. Cl. G06Q 20/02; G06Q 20/40

(52) U.S. Cl. CPC G06Q 20/02; G06Q 20/401

(57) ABSTRACT

A computer system for securing communicating information, such as electronic payment address information, between payors and payees and for processing electronic payments. The system providing a third party service that can aggregate verified payee information over a plurality of transactions to increase the safety of electronic payments.

### CLAIM OF PRIORITY

This application claims the benefit of U.S. Provisional Patent Application Ser. No. 62/347,876 filed Jun. 9, 2016, which is hereby incorporated by reference in its entirety.

### TECHNICAL FIELD

Embodiments described herein relate generally to data security, and in particular to a computer system that provides enhanced onboarding of new customers of electronic payment systems and to perform delivery of payments to payees.

### BACKGROUND

Potential customers of an electronic payment solution already have a method of paying their payees. For most payees, that includes an ability to physically deliver a payment (e.g., by physical mail), typically in the form of a check. For some payees like temporary farm workers, that may include a specific rendezvous point to physically be presented with a payment instrument (e.g., cash, check, or money order).

Many payors have electronic contact or electronic payment information for only a small fraction of their payees. Additionally, there are numerous directories of potential payees that do not include epayment address. Also, payment information for a payee from one payor cannot be directly trusted by other payors that have a responsibility to ensure delivery.

There is a need in the art for a system that provides easier onboarding of new customers of electronic payment systems. Such a system would enable payors to obtain electronic payment information for each payee and securely associate it with the intended payee.

### BRIEF DESCRIPTION OF THE DRAWINGS

FIG. 1 is a block diagram of a system including a third party service with database for communicating information between payors and payees, according to one embodiment of the present subject matter.

FIG. 2 is a block diagram illustrating a machine in the example form of a computer system, within which a set or sequence of instructions may be executed to cause the machine to perform any one of the methodologies discussed herein, according to one embodiment of the present subject matter.

### DETAILED DESCRIPTION

The present disclosure teaches a system that provides easier onboarding of new customers of electronic payment systems. In various embodiments, the system enables payors to obtain electronic payment information for each payee and securely associate it with the intended payee. In various embodiments, such systems can accumulate that information in a directory so that shared payees can be paid immediately. For purposes of this disclosure the electronic payment information is called an epayment address.

In various embodiments the system will acquire and build directories of epayment addresses for directory members, and leverage that directory information to expedite and build trust in the epayment address accumulated for payees. In various embodiments, the payor will coordinate how it issues payment with getting epayment addresses.

In typical payment processes, a payor would give account information to a payee. For example, a homebuyer with a loan might give address information to its mortgage lender. The mortgage lender/payee would then verify epayment information (e.g., try a transaction using the homebuyer's bank account). If that worked, the mortgage lender/payee would get electronic payments in the future from that bank account.

Sometimes an ACH verification was performed which involved a third party sending a secret amount to a checking account of a customer. The customer would know how much was deposited, and inform the third party of that amount. That served as a verification that the right bank account was involved for future transactions and that the customer actually had access to it via the bank.

A basic onboarding process implemented in an online service according to one embodiment of the present subject matter includes, but is not limited to:
1. A payor uploads to onboarding system information about payee, including the payor's unique ID for the payee (called a payee ID) and any known contact information such as physical address.
2. An onboarding system generates a unique token per payee (called the onboarding secret).
3. A payor downloads the payee information including the onboarding secret.
4. A payor generates and mails to payees a physical mailing that invites them to the system, and includes the code.
5. A payee visits an onboarding site, enters an epayment address.
6. A payor retrieves the epayment addresses for future payments to that payee.

This process uses the existing trusted path to the payee used for physical delivery of existing payments to deliver the onboarding secret token to the payee. The payee presents that secret to the onboarding system along with epayment address, confirming that the epayment address corresponds to the physical address provided by the payor.

While this basic process enables largely self-service onboarding, it takes multiple days, requires multiple steps on the part of the payor and payee, and doesn't result in an epayment address for payees that other payor's could trust.

In various embodiments, the present subject matter allows for the use of a trusted service to support onboarding. Such a service can enable shared, reliable onboarding across multiple payors, thus amortizing onboarding efforts and costs, and reducing the effort and cost to bring on new payor and payees.

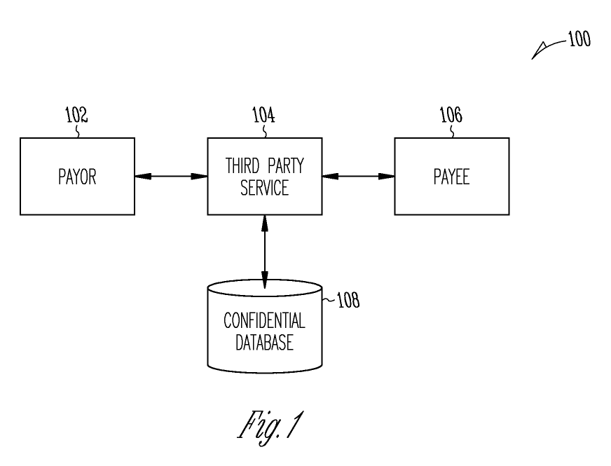

FIG. 1 is a block diagram of computer system including a third party service with database for communicating information between payors and payees, according to one embodiment of the present subject matter. Third party service 104 provides an interface between payors 102 and payees 106 in system 100. Third party service 104 can store payee information in confidential database 108. In various embodiments, the payor 102 has original address information (e.g., trusted physical address of payee 106 or other unverified contact information such as email address or phone number, etc.) The confidential database 108 can associate a variety of possible original address information with verified epayment address information. In various embodiments, a payor 102 can make payments to a payee using an email address for that payee stored in confidential database 108 and accessible by third party service 104. In some embodiments, the email address is corroborated by third party service 104 to ensure the payments go to the proper payee 106.

In various embodiments of the present subject matter, the system, among other things, can perform one or more of the following:
allow the payor to provide original address information relating to payee identity that is trusted by the payor, but which is not necessarily a trusted address for epayment purposes;
provide a third party service (TPS) that compares the original address information to its verified epayment information associated with that payee;
   This can be done using a database, such as shown in FIG. 1.
   If the database does not contain verified epayment information for that payee, the system can contact the payee to obtain secure, trusted epayment information.
      One way to obtain that information is to send a secret via a trusted path associated with the original address information to get an answer and the payee sends the secret back.
      Another way to obtain that information is that the payee can provide authenticating information to the third party service to ensure a valid epayment address.
      A person of skill in the art upon reading and understanding this disclosure will know that other methods may be used without departing from the scope of the present subject matter.
the payor may make payments to the payee using the third party service as a secure payment engine (this provides payee information that the payor can trust to securely deliver payments; an epayment address can be attached by the third party service and does not need to be disclosed to the payor); and
future inquires to the third party service that have the same original address information can safely use the associated verified epayment address.

The present subject matter may provide one or more of the following benefits:
In some embodiments, the contact to the payee that includes the onboarding secret is directly from the shared, trusted service (and not via the payor), so the secure binding between the original address information and the epayment address is can be trusted by other payors. In some embodiments, the payor sends an onboarding code.
Onboarding/payment requests are intelligently merged based on the original payment information from multiple payors and external directory information to be able to reuse and build trust in resulting epayment addresses.
Payments can be submitted for delivery to the payee, and then delivered in multiple media as selected by the payee when an epayment address is determined, or converted to physical delivery at the original payment address.

The improved onboarding system can allow the payor to download a print file (e.g., a PDF) for the mailing instead of downloading information for a mail merge file. In various embodiments, the system allows the payor to attach the onboarding code to a pending payment that will be delivered physically. That becomes “the last paper check you will receive; provide your epayment address for future payments.”

In various embodiments, onboarding by a trusted service is employed. In a basic onboarding process, the onboarding secret is communicated to the payee by the payor. In that basic process, anyone at the payor site with access to the payment data could take the onboarding secret and represent themselves as the payee. This is importantly not a significant risk for that payor because a person in such a position has direct access to the payment instrument itself. However, any epayment address retrieved that way could not be directly used on behalf of another payor because it would expose payments from the second payor to the misdirection setup by a bad actor at the first payor.

In various embodiments, the present subject matter eliminates this risk by sending the onboarding code to a payee from the trusted service. In this approach, the original payor never receives the onboarding code for a payee. Therefore, it cannot compromise it. The trusted service uses variable printing to produce payee-specific documents that include the payee's onboarding secret. The service delivers the document to the payee via the trusted path of original address information. When the payee uses that secret to provide epayment addresses, the trusted service then knows that the intended payee provided it. The “intended payee” is the party who would have received a payment delivered to the original address information.

In various embodiments, intelligent merging is used. If two payors happen to be paying the same payee (e.g., they use the same vendor), the system can provide different onboarding codes for each payor. But the present system achieves a competitive advantage and is enabled to create a payment directory if the system can reuse the epayment address for the payee. To do so, it will ensure it is referring to the same intended payee and ensure that the association from payee to epayment address is trustworthy. When multiple payors agree on the same epayment address, assurance of proper address information is strengthened.

The trusted system can determine that two payors are paying the same payee if the original address information is “the same”. In various applications, addresses are complex, so address matching to ensure that two payments are to the same payee may use fuzzy matching. In such applications, the system applies fuzzy matching along with trust information about the original source of data to determine whether the request of a second party for an epayment address can be satisfied by the results of onboarding a similar address for another payor. The assurance of the correctness of that match is increased by, including one or more of:
the accuracy of the match,
the number of independent payors that already agreed/matched on the epayment address,
the trustworthiness of the contributing payors in the case that the onboarding secret was passed through the payor,
additional data provided by the payee during onboarding,
confirmation notification delivered via the original address trusted path,
the number of successful epayments to the epayment address, and
public database information such as domain registries that attribute the epayment address to the specific internet domain.
   Other checks may be performed without departing from the scope of the present subject matter.

In various embodiments, original addressing is used. The original address can be a canonical ID in a public database (e.g., EIN, SSN, NPI, etc.), physical mailing address for the payee, notification email, fax number, social media address, etc. Any information or reference that can be used to form a trusted path such that a delivery on that path can be considered to be delivered to the intended party according to business “ordinary care”.

In various embodiments, onboarding is provided without a secret. With sufficient secondary authentication of the payee, transmission to the payee of an onboarding secret is unnecessary. For example, a payee can be contacted and verified based on shared transaction data from the payor, secrets provided via another party, or direct contact using the original address information (e.g., calling the provided cell number and getting epayment address information directly from the recipient).

In various embodiments, multimodal notification may be used. The notification to payees that includes the onboarding secret can be sent via multiple trusted paths from the original information. For example, a physical mailing could be sent, and a fax transmitted, and phone call made. These enable tradeoffs between time for onboarding and cost.

In various embodiments, multimodal payments may be performed. During onboarding, the payee can select from among several epayment process options, provide multiple epayment addresses for such options, or provide other profile corrections (e.g., improved contact information). With this approach, the onboarding portal can enable and support multiple epayment instruments. Examples are if the payee wants to establish an email address for echecks, a fax for payment notifications, and record account information for inbound ACH transactions.

In various embodiments, shared payee IDs may be used. In the onboarding process, the payor provides payee IDs to accurately and consistently designate payees. These payee IDs are unique to a group of payee contacts. Such groups may be unique or shared. The vendors of a large enterprise, for example, will be designate by an enterprise-wide vendor ID. Those vendor IDs may be used by multiple paying parties within and without the organization, but will have no relationship to the vendor IDs for some other organization.

Additionally, in various embodiments some payee IDs will be public identifiers. Thus, medical payments may use NPI (National Provider Identifier), businesses may use EINs, employers could use driver's license numbers, etc.

In various embodiments, paying payee IDs is enabled. An epayment system such as echecks associated with such an onboarding system can allow a payor to issue payments to a payee ID, without initially providing an epayment address. In this case, the final delivery of the epayment awaits completion of the onboarding process. Once the onboarding has completed, the epayment is delivered.

The original address information can be provided with the payment request, triggering onboarding for the intended payee of the pending payment.

The onboarding process can then additionally be influenced by the pending epayment, motivating escalation to use additional notification paths for onboarding.

In various embodiments, a fallback payment process may be offered. A payment that is awaiting onboarding (e.g., for a lower cost delivery to the payee) can have a policy based on which it selects a less-preferred but already-enabled payment mechanism. For example, the system attempts to get an email address to deliver an echeck, but falls back to printing a physically mailing a paper check after 21 days. This can enable payors with timeliness obligations to meet those while minimizing payment cost. It achieves this while avoiding error-prone coordination to revoke the original payment order and issue the payment via a different system.

The fallback payment can further include the onboarding code to encourage optimization of future payments.

In various embodiments, payment delivery may be provided. When the payee is at the third party site to provide an epayment address, they are the confirmed payee associated with the payee ID. If there are payments in the epayment system intended for them, they may be able to take receipt of the payments immediately.

In various embodiments, the system starts from another database. Several databases exist that already have potential payees with original address information. The onboarding service may proactively onboard those potential payees so that the epayment address information is immediately available if a payor wishes to pay the payee. Notable examples are EIN databases that include official business address, NPI databases that include official address for medical providers, an ACH directories for payees that currently accept ACH but that would be able to accept other forms of epayment.

In various embodiments, a referred identity process may be offered. The onboarding process may be triggered by the payor, by an agent working on behalf of the payor, or by the onboarding service itself. In each case, the onboarding code can be provided to the payee via any trusted communication path available the payor. If the payor has means of authenticating the payor, then they can initiate a connection with the payor without the onboarding code, complete authentication, and then redirect the payor along with the onboarding code to the onboarding site, and then continue as above. This allows the payor to use mechanism specific to the payor's relationship with the payee (register at a terminal when signing in in the morning) or the payor's industry.

In various embodiments, automatic extraction may be performed. If directed by the payor, using extension to existing payor software, the original address information can be extracted automatically. This enables seamless integration to migrate payees into receiving epayments. The priority and mechanism used to onboard each payee can vary based on the available information, the projected likelihood of a check to that payee in the near future, the volume of payments to the payee, etc.

In various embodiments, extensions may be used. Payments requested to payee IDs can have a final destination associated with a remote physical delivery process. For example, unbanked individual payees may opt to receive their check at a convenient grocery store, a specific bank, or a physical printing station. The same onboarding process could determine that logical location, and then the payee authenticates to that location however they mutually agree (e.g., present a driver's license).

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

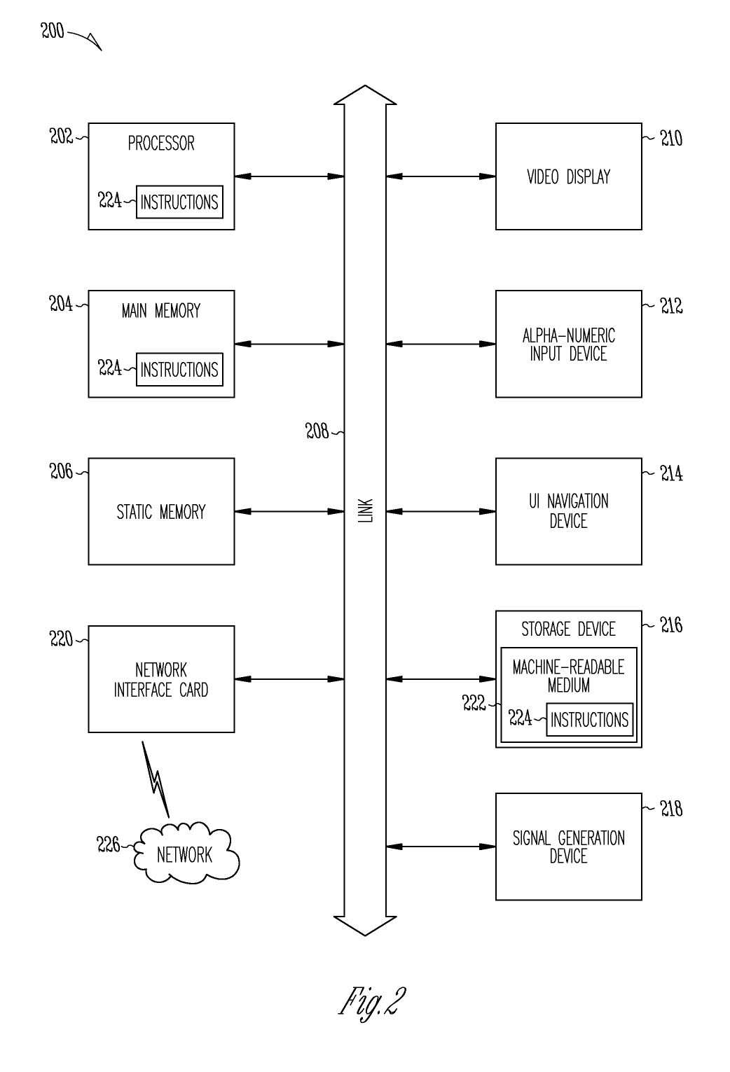

FIG. 2 is a block diagram illustrating a machine in the example form of a computer system 200, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments. In various embodiments, it may act as a peer machine in peer-to-peer (or distributed) network environments. The machine may be a personal computer (PC), a tablet PC, a hybrid tablet, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 200 includes at least one processor 202 (e.g., a central processing unit (CPU), a graphics processing unit (GPU) or both, processor cores, compute nodes, etc.), a main memory 204 and a static memory 206, which communicate with each other via a link 208 (e.g., bus). The computer system 200 may further include a video display unit 210, an alphanumeric input device 212 (e.g., a keyboard), and a user interface (UI) navigation device 214 (e.g., a mouse). In one embodiment, the video display unit 210, input device 212 and UI navigation device 214 are incorporated into a touch screen display. The computer system 200 may additionally include a storage device 216 (e.g., a drive unit), a signal generation device 218 (e.g., a speaker), a network interface device 220, and one or more sensors (not shown), such as a global positioning system (GPS) sensor, compass, accelerometer, or other sensor.

The storage device 216 includes a machine-readable medium 222 on which is stored one or more sets of data structures and instructions 224 (e.g., software) embodying or utilized by any one or more of the methodologies or functions described herein. The instructions 224 may also reside, completely or at least partially, within the main memory 204, static memory 206, and/or within the processor 202 during execution thereof by the computer system 200, with the main memory 204, static memory 206, and the processor 202 also constituting machine-readable media.

While the machine-readable medium 222 is illustrated in an example embodiment to be a single medium, the term “machine-readable medium” may include a single medium or multiple media (e.g., a centralized or distributed database, and/or associated caches and servers) that store the one or more instructions 224. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 224 may further be transmitted or received over a communications network 226 using a transmission medium via the network interface device 220 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

Various examples of the present subject matter are provided that may be deployed on a variety of computer systems, including, but not limited to the computer system of FIG. 2. In various examples, the present subject matter provides a method for onboarding payees and payors to a computer network using at least one computer operated by a third party in the computer network, including: receiving an electronic payment request at the at least one computer using the computer network, the payment request identifying a payment to a first payee including an identity of the first payee and some contact information associated with the first payee; querying a database of payee records using the at least one computer, each payee record having payment information for electronic payment; if the first payee is not in the database, obtaining electronic payment information for the first payee using the contact information of the first payee; and saving the electronic payment information for the first payee in the database; if the first payee is in the database, retrieving contact information for the first payee for use in the electronic payment request; and generating a unique onboarding code associated with the first payee. In one further example the method further includes sending the onboarding code to the first payor such that the first payor can use the onboarding code when submitting payment to the first payee. The method may include the sending is performed by mail from the payor to the payee. The method may also include receiving the onboarding code and electronic payment information for the first payee from the first payee, the electronic payment information including an electronic payment address of the first payee that is used for submissions of electronic payments. A further example of the method includes verifying the electronic payment address for the first payee using the at least one computer operated by the third party and saving verified electronic payment address information associated with the first payee in the database, wherein the database collects the contact and electronic payment information of each payee to provide a plurality of data sources for rapid verification and identification of electronic payment information for the payees.

Some examples include processing the payment request using the at least one computer operated by the third party to ensure the first payee is paid without the first payor receiving the electronic payment address of the first payee. In various examples the method includes receiving a second electronic payment request at the at least one computer from a second payor using the computer network, the second payment request identifying a second payment to a first payee including an identity of the first payee and some contact information associated with the first payee; querying the database of payee records using the at least one computer; retrieving contact information for the first payee; and comparing information from the second electronic payment request with the retrieved information to verify information associated with the first payee.

Some examples of the foregoing method include generating a second unique onboarding code associated with the first payee; and sending the second onboarding code to the second payor such that the second payor can use the onboarding code when submitting payment to the first payee. In some examples the method further includes receiving the second onboarding code and electronic payment information for the first payee from the first payee, the electronic payment information including an electronic payment address of the first payee that is used for submissions of electronic payments; and comparing the received electronic payment address with an electronic payment address stored in the database to verify the electronic payment address.

Variations of the method include receiving an electronic payment request at the at least one computer from a payor using the computer network, the second payment request identifying a second payment to a second payee including an identity of the second payee and some contact information associated with the second payee; querying a database of payee records using the at least one computer, each payee record having payment information for electronic payment; if the second payee is not in the database, obtaining electronic payment information for the second payee using the contact information of the second payee; and saving the electronic payment information for the second payee in the database; if the second payee is in the database, retrieving contact information for the second payee for use in the electronic payment request; and generating a unique onboarding code associated with the second payee. In certain embodiments the method includes generating a unique onboarding code associated with the second payee; and sending the onboarding code to the payor such that the payor can use the onboarding code when submitting payment to the second payee. And may include receiving the onboarding code and electronic payment information for the second payee from the second payee, the electronic payment information including an electronic payment address of the second payee that is used for submissions of electronic payments; and comparing the received electronic payment address with an electronic payment address stored in the database to verify the electronic payment address.

In various embodiments, these examples may further include applying fuzzy matching of various forms of data received from different transaction requests to the same payee to verify electronic payment address. Some examples include verifying electronic payment address information using information from a plurality of payment requests, the information verified using one or more of: a number of successful electronic payments to an electronic payment address; confirmation notifications received from prior payments; additional data provided by a payee during onboarding; and additional data provided by one or more payors. Some examples include verifying electronic payment address information using information from a plurality of payment requests, the information verified using public database information.

Various examples of the method include receiving a second electronic payment request at the at least one computer from a second payor using the computer network, the second payment request identifying a second payment to a first payee including an identity of the first payee and some contact information associated with the first payee; querying the database of payee records using the at least one computer; retrieving contact information for the first payee;

and determining that the first payee information is authentic without generating an onboarding code for the second electronic payment request. In some examples, the determining includes contacting the payee based on shared transaction data from the second payor. In some examples the determining includes directly contacting the payee using original address information. In some examples the determining includes using secrets provided by another to verify electronic payment address information. In some examples a second onboarding code is generated to provide an alternate path for verification of electronic payment information.

These examples are intended to demonstrate the present subject matter but are not intended to be an exhaustive or exclusive list of variations, and as such are not offered in a limiting sense.

This application is intended to cover adaptations or variations of the present subject matter. It is to be understood that the above description is intended to be illustrative, and not restrictive. The scope of the present subject matter should be determined with reference to the appended claims, along with the full scope of legal equivalents to which such claims are entitled.

What is claimed is:

1. A method for onboarding payees and payors to a computer network using at least one computer operated by a third party in the computer network, comprising:
receiving an electronic payment request at the at least one computer using the computer network, the payment request identifying a payment to a first payee including an identity of the first payee and some contact information associated with the first payee;
querying a database of payee records using the at least one computer, each payee record having payment information for electronic payment;
if the first payee is not in the database,
obtaining electronic payment information for the first payee using the contact information of the first payee; and
saving the electronic payment information for the first payee in the database;
if the first payee is in the database, retrieving contact information for the first payee for use in the electronic payment request; and
generating a unique onboarding code associated with the first payee.

2. The method of claim 1, further comprising:
sending the onboarding code to the first payor such that the first payor can use the onboarding code when submitting payment to the first payee.

3. The method of claim 2, wherein the sending is performed by mail from the payor to the payee.

4. The method of claim 2, further comprising:
receiving the onboarding code and electronic payment information for the first payee from the first payee, the electronic payment information including an electronic payment address of the first payee that is used for submissions of electronic payments.

5. The method of claim 4, further comprising:
verifying the electronic payment address for the first payee using the at least one computer operated by the third party and saving verified electronic payment address information associated with the first payee in the database,
wherein the database collects the contact and electronic payment information of each payee to provide a plurality of data sources for rapid verification and identification of electronic payment information for the payees.

6. The method of claim 5, further comprising:
processing the payment request using the at least one computer operated by the third party to ensure the first payee is paid without the first payor receiving the electronic payment address of the first payee.

7. The method of claim 4, further comprising:
receiving a second electronic payment request at the at least one computer from a second payor using the computer network, the second payment request identifying a second payment to a first payee including an identity of the first payee and some contact information associated with the first payee;
querying the database of payee records using the at least one computer;
retrieving contact information for the first payee; and
comparing information from the second electronic payment request with the retrieved information to verify information associated with the first payee.

8. The method of claim 7, further comprising:
generating a second unique onboarding code associated with the first payee; and
sending the second onboarding code to the second payor such that the second payor can use the onboarding code when submitting payment to the first payee.

9. The method of claim 8, further comprising:
receiving the second onboarding code and electronic payment information for the first payee from the first payee, the electronic payment information including an electronic payment address of the first payee that is used for submissions of electronic payments; and
comparing the received electronic payment address with an electronic payment address stored in the database to verify the electronic payment address.

10. The method of claim 4, further comprising:
receiving an electronic payment request at the at least one computer from a payor using the computer network, the second payment request identifying a second payment to a second payee including an identity of the second payee and some contact information associated with the second payee;
querying a database of payee records using the at least one computer, each payee record having payment information for electronic payment;
if the second payee is not in the database,
obtaining electronic payment information for the second payee using the contact information of the second payee; and
saving the electronic payment information for the second payee in the database;
if the second payee is in the database, retrieving contact information for the second payee for use in the electronic payment request; and
generating a unique onboarding code associated with the second payee.

11. The method of claim 10, further comprising:
generating a unique onboarding code associated with the second payee; and
sending the onboarding code to the payor such that the payor can use the onboarding code when submitting payment to the second payee.

12. The method of claim 11, further comprising:
receiving the onboarding code and electronic payment information for the second payee from the second payee, the electronic payment information including an electronic payment address of the second payee that is used for submissions of electronic payments; and
comparing the received electronic payment address with an electronic payment address stored in the database to verify the electronic payment address.

13. The method of claim 1, further comprising:
applying fuzzy matching of various forms of data received from different transaction requests to the same payee to verify electronic payment address.

14. The method of claim 13, further comprising:
verifying electronic payment address information using information from a plurality of payment requests, the information verified using one or more of: a number of successful electronic payments to an electronic payment address; confirmation notifications received from prior payments; additional data provided by a payee during onboarding; and additional data provided by one or more payors.

15. The method of claim 13 further comprising:
verifying electronic payment address information using information from a plurality of payment requests, the information verified using public database information.

16. The method of claim 4, further comprising:
receiving a second electronic payment request at the at least one computer from a second payor using the computer network, the second payment request identifying a second payment to a first payee including an identity of the first payee and some contact information associated with the first payee;
querying the database of payee records using the at least one computer;
retrieving contact information for the first payee; and
determining that the first payee information is authentic without generating an onboarding code for the second electronic payment request.

17. The method of claim 16, wherein the determining includes contacting the payee based on shared transaction data from the second payor.

18. The method of claim 16, wherein the determining includes directly contacting the payee using original address information.

19. The method of claim 16, wherein the determining using secrets provided by another to verify electronic payment address information.

20. The method of claim 1, wherein a second onboarding code is generated to provide a second path for verification of electronic payment information.
